(19) United States
(12) Patent Application Publication
(10) Pub. No.: US 2015/0234525 A1
(43) Pub. Date: Aug. 20, 2015

(54) POWERED CARD WITH TOUCH DISPLAY

(71) Applicant: POWERED CARD SOLUTIONS, LLC, Lakeland, FL (US)

(72) Inventor: Shimon Yisraelian, Nes Ziona (IL)

(21) Appl. No.: 14/425,688

(22) PCT Filed: Aug. 28, 2013
(86) PCT No.: PCT/US13/57035

§ 371 Date: Mar. 4, 2015

Related U.S. Application Data
(60) Provisional application No. 61/696,522, filed on Sep. 4, 2012.

(51) Int. Cl. G06F 3/041; G07F 7/08; G06F 3/0488; G06F 3/044; G06F 3/0484

(52) U.S. Cl. CPC G06F 3/0416; G06F 3/0412; G06F 3/044; G06F 3/04847; G06F 3/04883; G07F 7/0833; G07F 7/0846

(57) ABSTRACT

Powered cards comprising a substrate, a touch-sensitive display, display driver circuitry, a power source and a controller are described. The controller activates the display driver circuitry when a user of the card touches the display. The touch-sensitive display can be a liquid crystal display LCD which does not comprise a touch sensitive sensor separate from the display. Touch can be detected by measuring the capacitance between a conductor or segment and the common conductor of the display, wherein capacitance between a conductor segment and the common conductor is higher when the display is touched in an area near the segment. Capacitance between a conductor segment and the common conductor can be determined by measuring the time required for a segment of the display to transition to an on state during switching while the display is being driven by the display driver circuitry.

This application claims the benefit of Provisional U.S. Patent Application Ser. No. 61/696,522, filed on Sep. 4, 2012, pending, which is incorporated by reference herein in its entirety.

### BACKGROUND

1. Field

This application relates generally to electronic display cards and, in particular, to electronic display cards having a touch activated display and to method of using such cards.

2. Background of the Technology

The electronic display card industry is struggling today with some recognized limitations. Display cards have high manufacturing costs resulting from the high cost of the electrical components, displays and assembled modules. The high costs associated with these cards limits market penetration with appropriate margin to the supply chain. There is also a shortage of space on standard cards measuring 8 cm by 5 cm. Such space limitations are more evident in cards having keypads with multiple buttons. The full module with touch pad in such cards does not leave much room for all the standard credit card requirements thereby forcing compromises.

The mechanical height of components suitable for use in cards of standard thickness does not enable the use of the more advanced touch displays currently employed in more up to date devices such as smart phones. The low reliability of the display and connections due to many direct drive displays and the requirement for many digits and even bitmap displays is also a shortcoming of current display cards. The reliability and functionality of ON switches or activation buttons is also very low. The current industry lamination process and facing attachment are not accurate. In addition, metal dome switch resistivity can change over time and presents a different experience of use in each card and over time. The accumulation of these problems presents difficulties for many users in operating the display card, especially users with long finger nails, unstable hands or weak fingers.

Accordingly, there still exists a need for improved electronic display cards which have increased functionality and reliability and which can be manufactured at low cost.

### SUMMARY

A card is provided which comprises:
a substrate;
a touch-sensitive display;
display driver circuitry;
a power source; and
a controller;
wherein the controller activates the display driver circuitry when a user of the card touches the display.

According to some embodiments, the controller activates the display driver circuitry when a user of the card touches the display with a sliding or tapping motion. According to some embodiments, the touch-sensitive display does not comprise a touch sensitive sensor separate from the display layers or touch sensitive areas around the display.

According to some embodiments, the touch-sensitive display is a liquid crystal display (LCD) comprising a plurality of conductor segments and a common conductor wherein touch is detected by measuring the capacitance between one or more of the conductor segments and the common conductor. Capacitance between a conductor segment and the common conductor is higher when the display is touched in an area near the segment. According to some embodiments, capacitance between a conductor segment and the common conductor is determined by measuring the time required for a segment of the display to transition to an on state during switching while the display is being driven by the display driver circuitry

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIGS. 1A-1D is a schematic representation of the touch sensitive display on the card being used to display a code such as a one time passcode (OTP).

FIGS. 2A-2D is a schematic representation of the touch sensitive display on the card being used to enter a code into the card.

FIG. 3A-3D is a schematic representation of the touch sensitive display on the card being used to select a function.

FIG. 4A is a schematic representation of a conventional display card having an 8 digit display, ON-OFF buttons and a plurality of keypad buttons for data entry.

FIG. 4B is a schematic representation of a display card as described herein having a four (4) digit touch sensitive display wherein the ON-OFF buttons and the plurality of keypad buttons for data entry have been eliminated.

FIG. 5A is a schematic showing the segment structure for a direct drive display.

FIG. 5B is a schematic showing the segment structure for a multiplex drive display.

FIG. 6 is a schematic representation of a simplified equivalent circuit of a direct drive display wherein C_{load} represents segment capacitance.

FIG. 7 is a schematic showing panel driving waveforms for a direct drive display.

FIG. 8 shows an exemplary driving and sensing circuitry structure for a direct drive display.

### DESCRIPTION OF THE VARIOUS EMBODIMENTS

Powered cards comprising a thin touch sensitive display without any external touch sensitive layer wherein the display can be used for entering data in addition to displaying data are provided. This powered display cards enable the module designer to eliminate the need for an ON button by using the display as the ON button. Moreover, the same identical display which is used to display the information is a touch pad for entering data thereby turning the display card into an interactive device. The display can be either a segmented or a bitmap display. The display can be liquid crystal (LC), twisted nematic (TN), super-twisted nematic (STN), electrophoretic ink (E-ink) or Polymer Dispersed Liquid Crystal (PDLC) display with different driving schemes. Examples of use and various embodiments are described below.

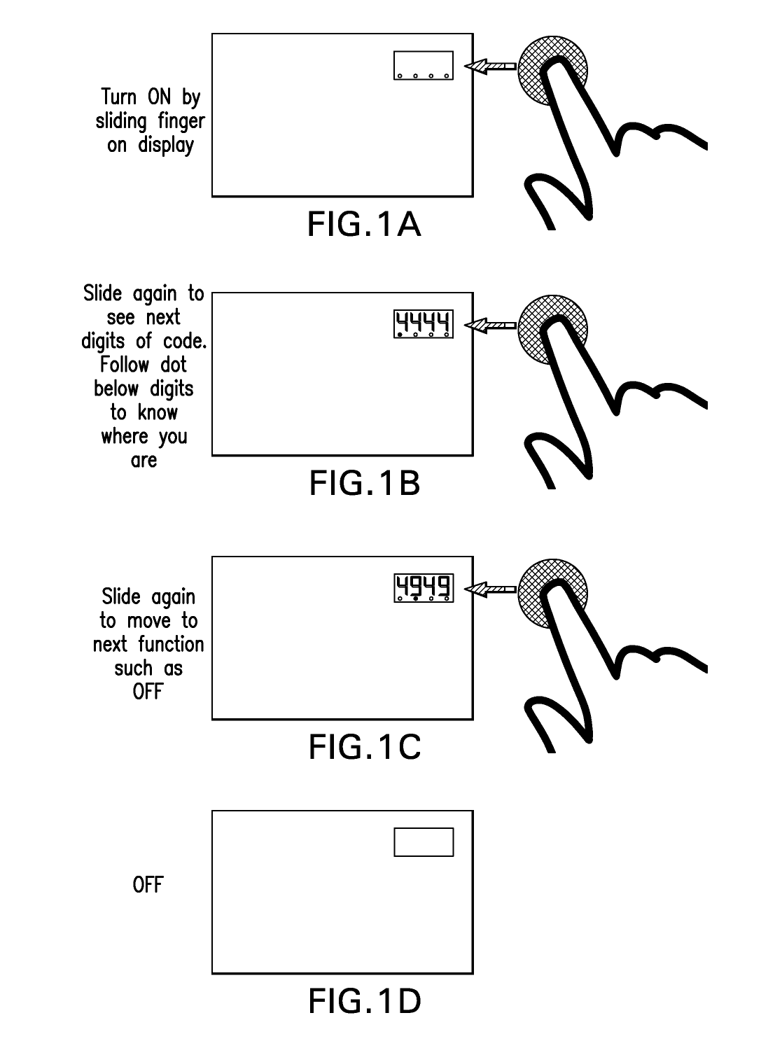

According to some embodiments, the display can be used to display an alphanumeric code such as a one time passcode. An example of the use of a card to display a code is shown in FIG. 1. As shown in FIG. 1A, the display on the card is initially off. As shown in FIG. 1A, the display is activated when the user slides a finger over the display or taps the display. As shown in FIG. 1B, activation of the display results in the display of a plurality of alphanumeric digits on the display. Although a display having four characters is shown, displays comprising either more or fewer characters can be used. After initial activation, the first sequence of characters displayed is the first portion of the code. As shown in FIG. 1B, when the user subsequently touches the display using a sliding motion the display shows the next portion of the code.

As also shown in FIG. 1, the display can comprise a plurality of indicators. An indicator can be associated with each of the digits of the display. For example, as shown in FIG. 1, an indicator is located beneath each digit of the display. The indicator can indicate which portion of the code is currently being displayed. For example, when the indicator associated with the first digit is on, the first portion of the code (i.e., the first n digits wherein n is the number of digits in the display) is being displayed. Similarly, when the indicator associated with the second digit is on, the second portion of the code (i.e., the second n digits) is being displayed.

The card shown in FIG. 1 allows for the display of a code having more characters than the display. For example, using a four character display a code having 8, 12 or 16 characters can be displayed. In the case of a 16 digit code, activation of the display would show the first four digits of the code and each successive activation of the display by sliding contact would show the next for digits.

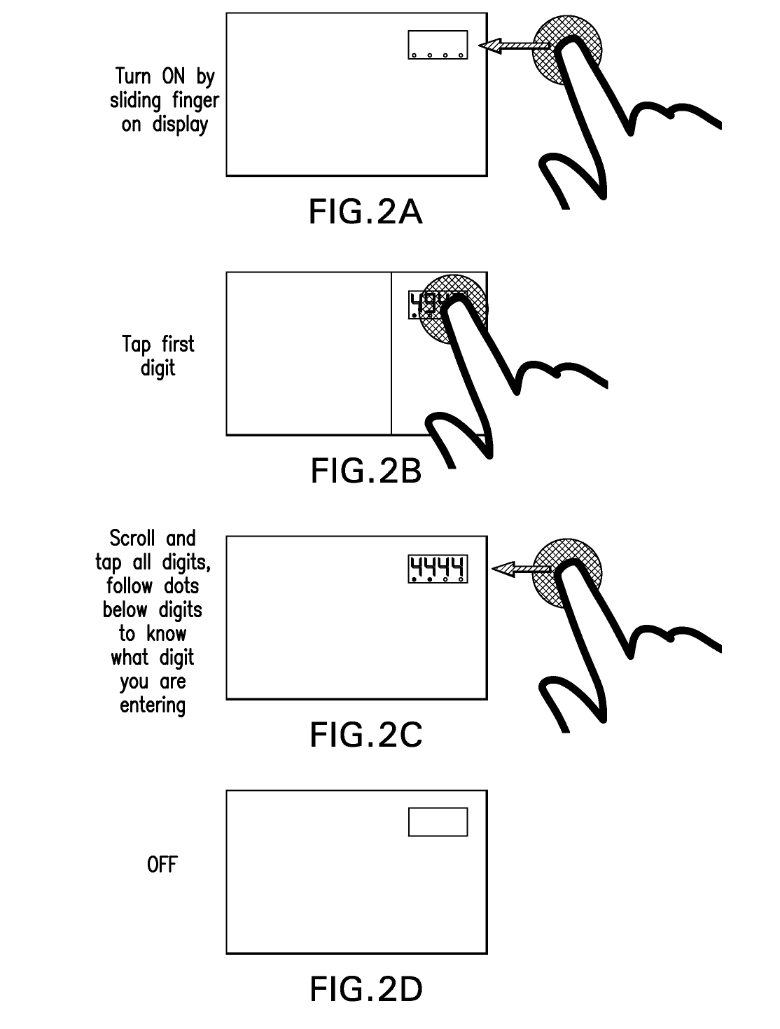

According to some embodiments, the touch sensitive display can also be used to enter information into the card. An embodiment is shown in FIG. 2 wherein the touch sensitive display is used to enter an alphanumeric code (e.g., a one time passcode) into the card. As shown in FIG. 2A, the display is initially off. As shown in FIGS. 2A and 2B, by contacting the display with a sliding motion a first sequence of alphanumeric digits (0, 1, 2, 3 shown) is displayed. The user can then select which if any of the displayed digits to enter. The digit can be entered by pressing or tapping the digit that appears on the display. Once the digit is entered or if the desired digit does not appear on the display, the user can scroll to the next sequence of alphanumeric digits (e.g., 4, 5, 6, 7) by again contacting the touch display with a sliding motion. In this manner, a code comprising multiple digits can be entered into the card.

As also shown in FIG. 2, the display can comprise a plurality of indicators. An indicator can be associated with each of the characters of the display. For example, as shown in FIG. 2, an indicator is located beneath each character of the display. The indicator can indicate the characters of the code which have already been entered. For example, after the first character has been entered, the indicator associated with the first character can be activated as shown in FIG. 2B. Similarly, after the second character of the code has been entered, the indicator associated with the second character can be activated as shown in FIG. 2C. The activated indicator therefore shows that an entered character of the code is being displayed.

As shown in FIG. 2, the display initially shows 4 digits (e.g., 0, 1, 2, 3). Scrolling right or left be sliding contact reveals the next set of digits (4, 5, 6, 7) or (8, 9). When the desired character is displayed, the display is touched on that character. The display can then be scrolled again and additional characters selected until you the entire code has been entered. The indicators on the bottom of the display can be used to determine which digit is being entered or to go on to the next function.

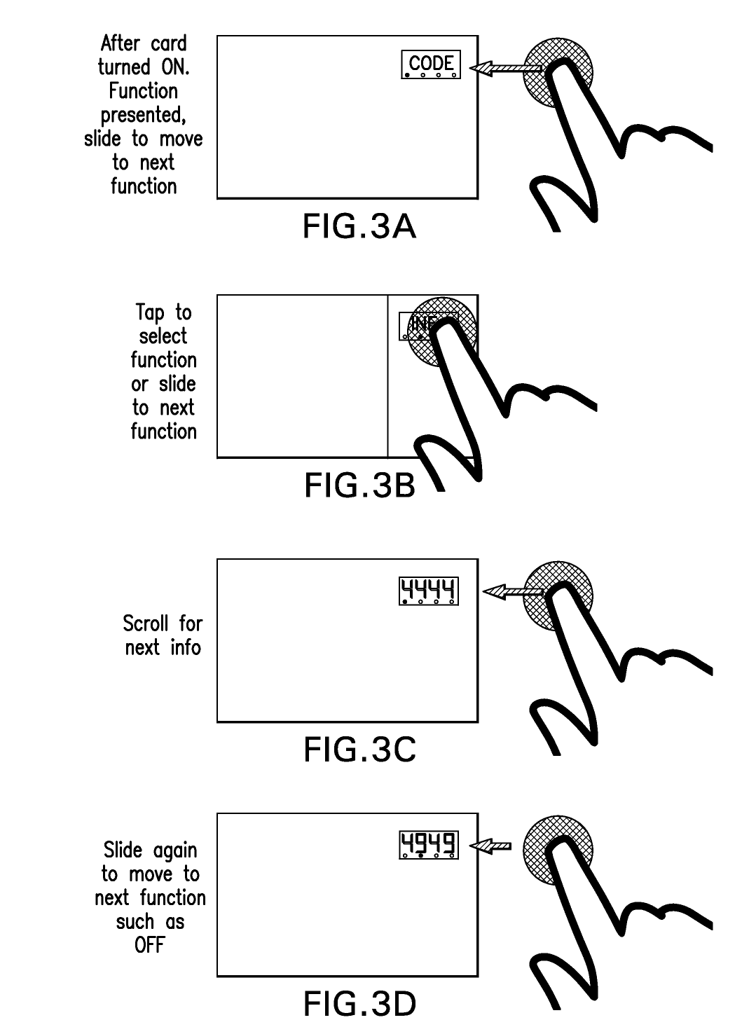

According to some embodiments, the touch sensitive display can also be used to select a function as shown in FIG. 3. As shown in FIG. 3A, the display is initially off. As shown in FIGS. 3A and 3B, by contacting the touch sensitive display with a sliding motion, an alphanumeric sequence representing a function of the card is displayed. For example, as shown in FIG. 3A the word “CODE” can appear on the display to represent the function for entry of a code into the card. Alternatively, as shown in FIG. 3B, the word “INFO” can be displayed to represent the function of retrieving information from the card. The desired function can be selected by tapping or pressing the display when the code representing that function is displayed. By contacting the display with a sliding motion, different functions of the card can be displayed. As shown in FIG. 3C, once the desired function has been selected, additional options can be displayed within that function by contacting the display with a sliding motion.

As shown in FIG. 3, the display can also comprise a plurality of indicators. An indicator can be associated with each of the characters of the display. For example, as shown in FIG. 3, an indicator is located beneath each character of the display. The indicator can indicate which option or function is currently being displayed. Example of additional indicators can be, currency (e.g., $, EUR,) or mode of operation or battery low, etc.

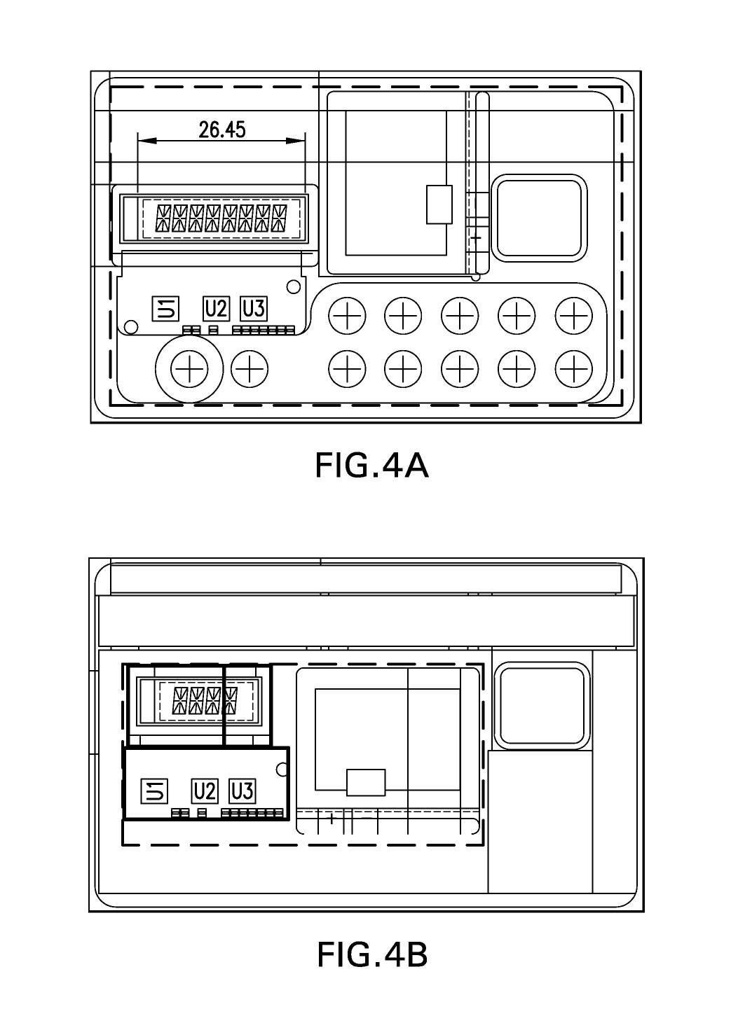

Using a touch sensitive display to scroll data allows for the use of a smaller display size and improves the user experience as shown in FIGS. 4A and 4B. For example, the touch sensitive display can be used as an on-off switch thereby eliminating the need for a separate on-off switch. FIG. 4A shows a conventional card having an ON switch and FIG. 4B shows a card as described herein wherein the touch sensitive display is used as the ON switch.

The touch sensitive display can also be used to enter information into the card such as a one time passcode (OTP) thereby eliminating the need for keypad buttons. The fact that the user eye is exactly where the finger is, makes it easier for the user to focus on the action and reduces the need for the user's eye to wander across the card to select the appropriate button and then come back to the display. FIG. 4A shows a conventional card having keypad buttons and FIG. 4B shows a card as described herein without buttons wherein the touch sensitive display is used to enter information into the card.

Since information can be scrolled across the touch sensitive display, smaller displays (i.e., displays having fewer digits) can be used. As a result, the display driver circuits needed to drive the displays can be reduced in size. FIG. 4A shows a conventional card having an eight (8) digit display and FIG. 4B shows a card as described herein having a four (4) digit touch sensitive display which can be scrolled by the user to display eight (8) or longer digit codes. The use of smaller displays as described herein can also reduce the cost of manufacturing the card and result in increased card reliability. In summary, cards having touch sensitive displays as described herein can be manufactured at lower cost by eliminating the need for all switches from the card and by using smaller display drivers and smaller flexible displays.

The user may use the scrolling up and down or diagonal in the display as required by the application.

The user may use two fingers to zoom in or out of the info for more convenient use when bit map displays are used. For example when larger number is required due to impaired vision.

The card may comprise a solar sensor to generate current while the card is used. For example, the card can be used only in light due to the reflective display being used. By using a solar sensor, power consumption can be reduced during operation. In this manner, battery power and size can be reduced when using a solar driver. One may use the touch display to turn the module OFF after the card has been used.

One may use the said solar sensor to save current while the card is in idle mode. When the card is in the dark, usually in the wallet, the touch sense scanning can be stopped and thus save current.

One may use the said solar sensor to turn the module OFF automatically after the card has been used and put in dark place.

One may use the said solar sensor combined with logic and the display touch to turn the module ON or OFF.

According to some embodiments, the touch display can be tapped or pressed for further functionality.

According to some embodiments, multiple touch displays can be used in one card for additional functionality.

According to some embodiments, multiple touch displays can be used from single side or both sides of the card for additional functionality.

Any type of touch sensitive electronic display that can be incorporated into a card can be used. Exemplary types of displays include, but are not limited to, liquid crystal (LC), twisted nematic (TN), super-twisted nematic (STN), electrophoretic ink (E-ink, Gemalto (using Aveso technology) and Polymer Dispersed Liquid Crystal (PDLC) displays.

Any drive technology can be used for the display including, but not limited to, direct drive, multiplexed drive with few commons, TFT and printed transistors.

A display having any size or shape or with any graphics or pixel size can be used.

According to some embodiments, the touch sensitive display relies upon the inherent capacitance of the display. For example, with LCD displays, there is inherent capacitance between each segment conductor and common conductor in the display. As with a regular touch sensor, when a finger is located near the segment capacitor, the capacitance of the segment capacitor increases due to the fact that the finger creates additional capacitance between the finger and the segment.

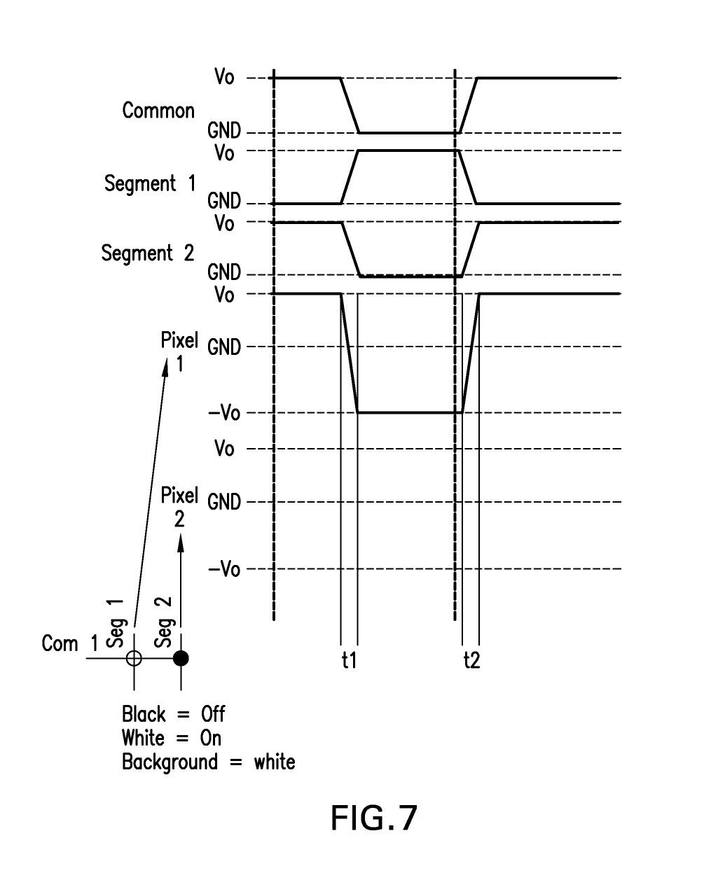

A panel driving waveform for a direct drive display is shown in FIG. 7. In FIG. 7, voltage is shown as a function of time for the conductor common and a first and second segment of the display (i.e., “Segment 1” and “Segment 2”). In FIG. 7, Segment 1 is on and Segment 2 is off. The times t1 and t2 in FIG. 7 are the times required for Segment 1 to transition from the off state to the on state and from the on state to the off state, respectively, during switching. In the example shown in FIGS. 7, t1 and t2 are the times for switching to keep present pixel state. This is the refresh signal which is required in case of non stable LC displays.

In order to detect touch when using LC displays, the driver is used to drive the display refresh signal as usual and the time of the transition is determined. For example, the slope of the transition can be determined during each refresh transition (e.g., every 30 msec) in regular LC displays. If the transition is relatively fast (i.e., regular), the display is not being touched in the area near the segment. If the transition is relatively slow (i,e capacitance is enlarged), the display is being touched in the area near the segment.

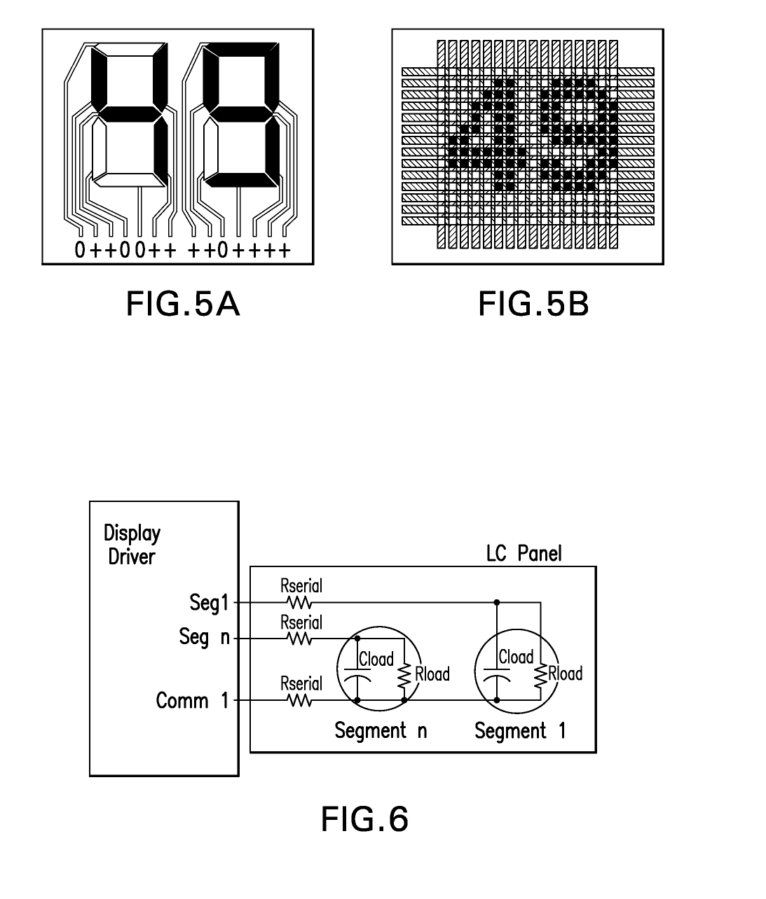

FIG. 5A shows an exemplary segment structure for a direct drive display. FIG. 5B shows an exemplary segment structure for a multiplex drive display.

The driver waveforms used to perform detection should not interfere with the display. Various types of electrical circuitry can be used to implement the touch screen function. According to some embodiments, the card comprises circuitry to drive additional signals not effecting the display but only enabling the sensing of the finger presence. According to some embodiments, the card uses sensing circuitry to check how fast the refresh LC switching is done. When the display is being touched near the segment, the pixel capacity rises and switching will be slower than when the segment is not being touched.

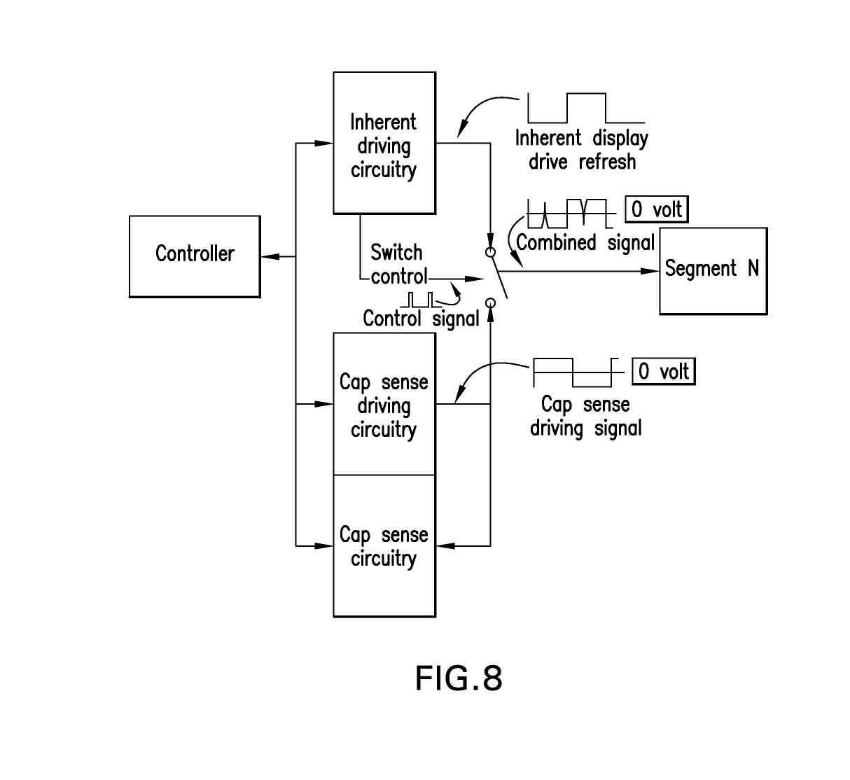

In order to detect touch when using Bistable or TFT family displays, an additional detection method can be used. According to this method, an inherent driver can be used with additional dedicated circuitry. The inherent driver drives the display to show the required data for the user. Before or after the display setup, an alternative drive and sense circuit is connected. This circuit is only driving current for a short time and sensing the charge\discharge time. The very short current does not affect the appearance of the display to the user due to the low energy which is applied to the pixels. FIG. 8 shows an exemplary driving and sensing circuitry structure for a direct drive display.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A card comprising:
a substrate;
a touch-sensitive display;
display driver circuitry;
a power source; and
a controller;
wherein the controller activates the display driver circuitry when a user of the card touches the display.

2. The card of claim 1, wherein the controller activates the display driver circuitry when a user of the card touches the display with a sliding or tapping motion.

3. The card of claim 1, wherein the touch-sensitive display does not comprise a touch sensitive sensor separate from the display or touch-sensitive areas adjacent to the display.

4. The card of claim 1, wherein the touch-sensitive display is a liquid crystal display (LCD) comprising a plurality of conductor segments and a common conductor and wherein touch is detected by measuring the capacitance between one or more of the conductor segments and the common conductor, wherein capacitance between a conductor segment and the common conductor is higher when the display is touched in an area near the segment.

5. The card of claim 4, wherein capacitance between a conductor segment and the common conductor is determined by measuring the time required for a segment of the display to transition to an on state during switching while the display is being driven by the display driver circuitry.

6. The card of claim 1, wherein the display provides information when the display driver circuitry is activated.

7. The card of claim 6, wherein the information comprises an alphanumeric code.

8. The card of claim 7, wherein the alphanumeric code is a one time passcode.

9. The card of claim 1, wherein the controller activates the display in the card to show additional information each time the user of the card touches the display with a sliding motion.

10. The card of claim 1, wherein the display shows a plurality of alphanumeric characters when the display driver circuitry is activated.

11. The card of claim 10, wherein the controller activates the display in the card to display a different sequence of alphanumeric characters each time the user of the card touches the display with a sliding motion.

12. The card of claim 10, wherein the plurality of alphanumeric characters comprises a sequence of consecutive integers or a sequence of consecutive letters.

13. The card of claim 10, wherein the controller allows the selection of an alphanumeric character appearing in the display by pressing that alphanumeric character in the display.

14. The card of claim 10, wherein the controller displays the selected alphanumeric digit in the display after the alphanumeric digit is selected.

15. The card of claim 10, wherein the display further comprises an indicator beneath each character of the display, wherein the indicator is activated when the character in the display is displaying a selected alphanumeric character.

16. The card of claim 10, wherein the controller allows a plurality of alphanumeric characters to be selected and displayed in the display by alternately sliding and pressing the display.

17. The card of claim 1, wherein the display is a liquid crystal display (LCD).

18. The card of claim 17, wherein the display comprises a plurality of characters and wherein each character comprises plurality of segments.

19. The card of claim 18, wherein an alphanumeric code is displayed on the display when the driver circuitry is activated.

20. The card of claim 11, wherein each sequence of alphanumeric characters is part of an alphanumeric code and wherein each successive activation of the display reveals a portion of the alphanumeric code.

21. The card of claim 20, wherein the display further comprises a plurality of indicators one of which is activated by the controller and driver circuitry when a portion of the code is being displayed, wherein the indicator that is activated indicates which portion of the code is being displayed.

22. The card of claim 21, wherein an indicator is associated with each character of the display.

23. The card of claim 22, wherein the display comprises n characters and n indicators wherein n is an integer of from 1 to 10.

24. The card of claim 23, wherein the activation of the n^{th} indicator indicates that the n^{th} portion of the alphanumeric code is being displayed.

25. The card of claim 11, wherein each sequence of alphanumeric characters represents a function.

26. The card of claim 16, wherein the controller and driver circuitry allow the selection of the function appearing in the display by pressing the display when the sequence of alphanumeric representing that function appears in the display.

27. The card of claim 1, wherein the display is a liquid crystal (LC) display, a twisted nematic (TN) display, a super-twisted nematic (STN) display, an electrophoretic ink (E-ink) display, or a polymer dispersed liquid crystal (PDLC) display.

28. The card of claim 1, wherein the card comprises a plurality of touch-sensitive displays.

29. The card of claim 28, comprising at least one touch-sensitive display on a front surface of the substrate and at least one touch-sensitive display on a back surface of the substrate.

30. The card of claim 1, further comprising drive and sense circuitry separate from the display driver circuitry.
